(19) United States
(12) Patent Application Publication
(10) Pub. No.: US 2025/0074228 A1
(43) Pub. Date: Mar. 6, 2025

(54) TEMPERATURE MANAGEMENT OF ELECTRIC VEHICLE SUPPLY EQUIPMENT

(71) Applicant: Siemens Industry, Inc., Alpharetta, GA (US)

(72) Inventors: Sesha Devasena Yeruva, Duluth, GA (US); Sheng-Min Chen, Burlington (CA); Imrich Kocai, Peachtree Corners, GA (US); Riley Callaghan, Marietta, GA (US)

(73) Assignee: Siemens Industry, Inc., Alpharetta, GA (US)

(21) Appl. No.: 18/458,212

(22) Filed: Aug. 30, 2023

(51) Int. Cl. B60L 53/302; B60L 53/18

(52) U.S. Cl. CPC B60L 53/302; B60L 53/18

(57) ABSTRACT

An electric vehicle charger includes a processor. The processor is configured to identify a first temperature and a second temperature from a sensor. The processor is configured to determine a rate change of temperature based on at least the first temperature at the first time point and the second temperature at the second time point. The processor is configured to prevent a maximum temperature threshold for the electric vehicle charger from being reached. The processor being configured to prevent the maximum temperature threshold from being reached includes the processor being configured to control an output of the electric vehicle charger based on the determined rate change of temperature and a predicted time to maximum temperature threshold.

### BACKGROUND

### 1. Field of the Disclosure

The present disclosure is generally directed to temperature management of electric vehicle supply equipment.

### 2. Description of Related Art

Electric vehicle supply equipment (EVSE) (e.g., an electric car charger) is a power supply device that supplies electrical power to recharge batteries of an electric vehicle. The two main types of EVSE include alternating current (AC) chargers and direct current (DC) chargers. AN AC charger includes an AC-to-DC converter that converts AC power from the grid to DC power for recharging the batteries of the electric vehicle.

The EVSE may be a Level 1 charger or a Level 2 charger. Level 1 chargers plug into standard 120 V outlets and may deliver up to 1.2 kW of electric power to the batteries of the electric vehicle when charging. Level 2 chargers use a 208-240 V power source and a dedicated circuit (e.g., up to 60 A). Level 2 chargers may deliver between 6.2 kW and 19.2 kW of electric power to the batteries of the electric vehicle when charging.

Conversion losses in the AC-to-DC converter of the AC charger, for example, are dissipated as heat. At a maximum power output of the Level 2 charger, for example, one or more temperatures of the charger may approach and/or reach threshold temperatures. Once one of the threshold temperatures is reached, the EVSE may react by interrupting the charging of the batteries of the electric vehicle.

The high temperatures within the EVSE may damage the EVSE and may increase a charging time for the electric vehicle. This may result in an electric vehicle that is not fully charged when the electric vehicle is needed and/or a user having to wait longer than expected to use the electric vehicle.

### SUMMARY

In one example, an electric vehicle charger includes a processor. The processor is configured to identify a first temperature and a second temperature from a sensor. The processor is configured to determine a rate change of temperature based on at least the first temperature at the first time point and the second temperature at the second time point. The processor is configured to prevent a maximum temperature threshold for the electric vehicle charger from being reached. The processor being configured to prevent the maximum temperature threshold from being reached includes the processor being configured to control an output of the electric vehicle charger based on the determined rate change of temperature and a predicted time to maximum temperature threshold.

In one example, the processor is further configured to identify the maximum temperature threshold for the electric vehicle charger, determine the predicted time to maximum temperature threshold based on the determined rate change of temperature and the identified maximum temperature threshold, and compare the predicted time to maximum temperature threshold to a predetermined time limit. The processor being configured to control the output of the electric vehicle charger based on the determined rate change of temperature and the predicted time to maximum temperature threshold includes the processor being configured to control the output of the electric vehicle charger based on the determined rate change of temperature and the predicted time to maximum temperature threshold when, based on the comparison, the predicted time to maximum temperature threshold is less than the predetermined time limit.

In one example, the electric vehicle charger further includes the sensor. The processor being configured to identify the first temperature and the second temperature from the sensor includes the processor being configured to receive the first temperature and the second temperature from the sensor.

In one example, the electric vehicle charger further includes a charging cable connector and a housing configured to support the processor and the charging cable connector. The sensor is located at the charging cable connector.

In one example, the electric vehicle charger further includes a memory in communication with the processor. The memory is configured to store the maximum temperature threshold and the predetermined time limit. The processor is further configured to identify the maximum temperature threshold and the predetermined time limit from the memory.

In one example, the processor is further configured to set a power of the electric vehicle charger to a maximum power when, based on the comparison, the determined time to maximum temperature threshold is greater than the predetermined time limit.

In one example, the processor being configured to control the output of the electric vehicle charger based on the determined rate change of temperature and the predicted time to maximum temperature threshold includes the processor being configured to compare the determined rate change of temperature to a predetermined slope threshold and decrease an output power of the electric vehicle charger when, based on the comparison of the determined rate change of temperature to the predetermined slope threshold, the determined rate change of temperature is greater than the predetermined slope threshold.

In one example, the decrease of the output power of the electric vehicle charger is inversely proportional to a difference between the second temperature and the first temperature.

In one example, the processor being configured to control the output of the electric vehicle charger based on the determined rate change of temperature includes the processor being configured to decrease the output power of the electric vehicle charger by a predetermined percentage when, based on the comparison of the determined rate change of temperature to the predetermined slope threshold, the determined rate change of temperature is less than the predetermined slope threshold.

In one example, the processor being configured to decrease the output power of the electric vehicle charger includes the processor being configured to decrease an output current by the electric vehicle charger.

In one example, the predetermined slope threshold is a first predetermined slope threshold. The processor being configured to control the output of the electric vehicle charger based on the determined rate change of temperature and the predicted time to maximum temperature threshold includes the processor being configured to compare the determined rate change of temperature to a second predetermined slope threshold and increase an output power of the electric vehicle charger when, based on the comparison of the determined rate change of temperature to the second predetermined slope threshold, the determined rate change of temperature is less than the second predetermined slope threshold.

In one example, the electric vehicle charger further includes a feedback controller configured to output a target output current based on one or more inputs to the feedback controller. The one or more inputs to the feedback controller are based on the first temperature and the second temperature identified from the sensor. The processor is configured to control the output of the electric vehicle charger based on the target output current output by the feedback controller.

In one example, the feedback controller is PID controller logic implemented on the processor.

In one example, the processor is further configured to identify a predetermined target temperature. The predetermined target temperature is less than the maximum temperature threshold. The processor is further configured to determine a first error and a second error. The first error is a difference between the predetermined target temperature and the first temperature, and the second error is a difference between the predetermined target temperature and the second temperature. The one or more inputs to the feedback controller include the first error and the second error.

In one example, the electric vehicle charger further includes a housing configured to support the processor and the feedback controller.

In one example, a controller for temperature management of electric vehicle supply equipment (EVSE) includes a processor in communication with a sensor associated with the EVSE. The processor is configured to identify a maximum temperature threshold for the EVSE and receive a first temperature and a second temperature from the sensor. The first temperature is at a first time point, and the second temperature is at a second time point. The second time point is after the first time point. The processor is further configured to determine a rate change of temperature based on the first temperature at the first time point and the second temperature at the second time point, determine a time to maximum temperature threshold based on the determined rate change of temperature and the identified maximum temperature threshold, and compare the determined time to maximum temperature threshold to a predetermined time limit. The processor is further configured to, when, based on the comparison, the determined time to maximum temperature threshold is less than the predetermined time limit, control an output of the EVSE based on the determined rate change of temperature.

In one example, the controller is a controller of the EVSE.

In one example, the processor being configured to control the output of the EVSE based on the determined rate change of temperature includes the processor being configured to compare the determined rate change of temperature to a predetermined slope threshold and, when, based on the comparison of the determined rate change of temperature to the predetermined slope threshold, the determined rate change of temperature is greater than the predetermined slope threshold, decrease an output power of the EVSE.

In one example, a method for temperature management of electric vehicle supply equipment (EVSE) includes identifying, by a processor, a first temperature and a second temperature from a sensor associated with the EVSE. The first temperature is at a first time point, and the second temperature is at a second time point. The second time point is after the first time point. The method includes determining, by the processor, a rate change of temperature based on at least the first temperature at the first time point and the second temperature at the second time point. The method includes preventing a maximum temperature threshold for the EVSE from being reached. Preventing the maximum temperature threshold for the EVSE from being reached includes controlling, by the processor, an output of the EVSE based on the determined rate change of temperature and a predicted time to maximum temperature threshold. Controlling the output of the EVSE includes generating, by a feedback controller, a target output current based on one or more inputs to the feedback controller. The one or more inputs to the feedback controller are based on the first temperature and the second temperature identified from the sensor. Controlling the output of the EVSE also includes controlling, by the processor, the output of the EVSE based on the target output current generated by the feedback controller.

In one example, the method further includes identifying, by the processor, the maximum temperature threshold for the EVSE, determining, by the processor, the predicted time to maximum temperature threshold based on the determined rate change of temperature and the identified maximum temperature threshold, and comparing, by the processor, the predicted time to maximum temperature threshold to a predetermined time limit. Generating, by the feedback controller, the target output current includes generating, by the feedback controller, the target output current based on the one or more inputs to the feedback controller when, based on the comparing, the predicted time to maximum temperature threshold is less than the predetermined time limit. The feedback controller is PID controller logic implemented on the processor.

### BRIEF DESCRIPTION OF THE DRAWINGS

Objects, features, and advantages of the present invention will become apparent upon reading the following description in conjunction with the drawing figures, in which:

FIG. 1 is a schematic diagram of one embodiment of an electric supply system including electric vehicle supply equipment (EVSE);

FIG. 2 shows a charging system;

FIG. 3 is a flowchart of one embodiment of a method for temperature management of EVSE; and

FIG. 4 shows one embodiment of a computer system for use with the electric supply system of FIG. 1 and/or the charging system of FIG. 2.

### DETAILED DESCRIPTION OF THE DISCLOSURE

Temperature management of electrical vehicle supply equipment (EVSE) of the prior art is reactive in that charging is stopped when a threshold temperature is reached at a location in and/or on the EVSE. This leads to a poor user experience with charging starting and stopping over a prolonged charging session.

The temperature management of EVSE of the present embodiments is proactive in that a rate of change of temperature may be considered in the control of output power of the EVSE, so that charging is not stopped due to a threshold temperature being reached. For example, a rate change of temperature is determined based on temperature sensor measurements at a location on and/or in the EVSE (e.g., a plug of the EVSE) over a period of time. A time to maximum temperature is determined based on the determined rate change of temperature and a difference between the maximum temperature threshold and a current temperature at the EVSE location. The time to maximum temperature is compared to a predetermined time limit, and when, based on the comparison, the time to maximum temperature threshold is less than the predetermined time limit, output of the EVSE is controlled. In other words, output of the EVSE is controlled when the determined rate change of temperature indicates the maximum temperature threshold may be reached before the charging of the electric vehicle is complete.

The determined rate change of temperature may be compared to at least one slope threshold to determine how the output of the EVSE is to be controlled. When, based on the comparison, the determined rate change of temperature is greater than a positive slope threshold, the output of the EVSE may be controlled based on the determined rate change of temperature (e.g., a temperature difference of the rate change of temperature).

The proactive nature of the temperature management of EVSE of the present embodiments prevents the charging interruptions due to the temperature management and may minimize charging times.

These and other objects, features, and advantages will become apparent to those having ordinary skill in the art upon reading this disclosure. Throughout the drawing figures, where like reference numbers are used, the like reference numbers represent the same or substantially similar parts among the various disclosed examples. Also, specific examples are disclosed and described herein that utilize specific combinations of the disclosed aspects, features, and components of the disclosure. However, it is possible that each disclosed aspect, feature, and/or component of the disclosure may, in other examples not disclosed or described herein, be used independent of or in different combinations with other of the aspects, features, and components of the disclosure.

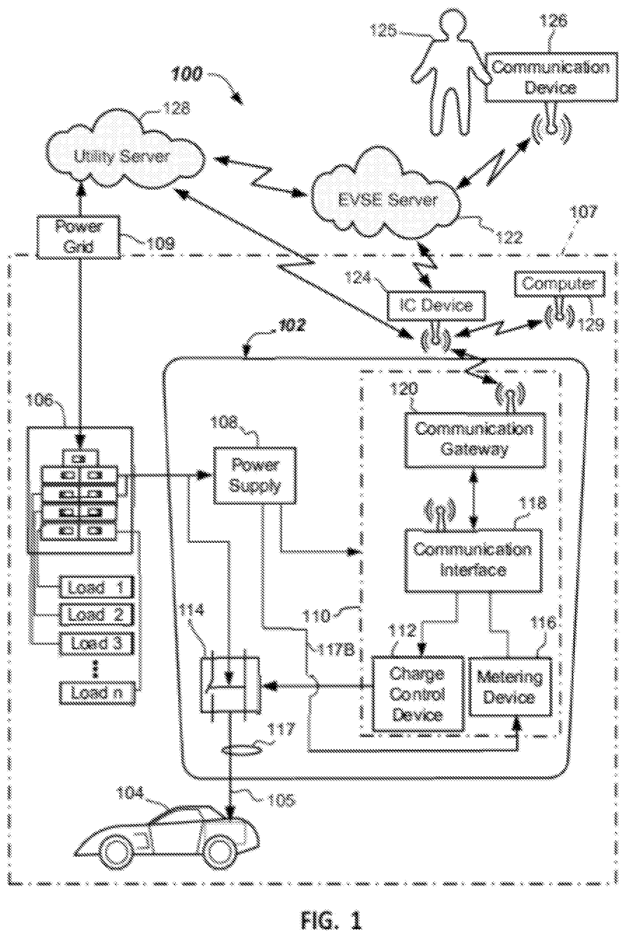

Turning now to the drawings, FIG. 1 illustrates an embodiment of an electrical supply system 100 for an electric vehicle (EV) 104, including electric vehicle supply equipment (EVSE) 102. The EVSE 102 is configured to couple to, and electrically charge, a power storage device (e.g., battery or batteries-shown dotted) of the EV 104. The EV 104 may be a fully-electric vehicle or a hybrid vehicle. Electrical charging may be supplied to the EV 104 by a charging cable 105 having an electrical connector (not shown) that electrically couples to a receiving connector (not shown) on the EV 104.

The EVSE 102 may be electrically coupled to a load center 106 (e.g., a panel box including circuit breakers, or the like) of a building 107 (shown dotted). However, in some instances, the EVSE 102 may be outside of the building 107. The EVSE 102 may be coupled as an electrical load on one branch of an electrical circuit and may receive electrical power from the load center 106. The load center 106 may be connected to a power grid 109. A typical load center 106 may have a 240 V, 200 A service, for example. However, other load center types and sizes may be used for supplying the EVSE 102. Other electrical branch circuits containing one or more electrical loads (loads 1-n) may also be coupled to the load center 106. Any suitable number of branch circuits may be connected based upon a rating and a size of the load center 106. One or more of the branch circuits may also couple to and include one or more subpanels.

In more detail, the EVSE 102 may include a power supply 108 configured to provide electrical power sufficient for the various control, metering, processing, and communication components of the EVSE 102, to be described later herein. The power supply 108 may be a 240 V, 100 mA power supply, for example. Other suitable types and sizes of power supply 108 may be used. The EVSE 102 may include a printed circuit board 110 (shown dotted) including multiple interconnected microprocessors, electrical circuits, and components thereon.

In the depicted embodiment, the EVSE 102 may include a charge control device 112 that is operable to process a control signal (e.g., a charge signal) representative of a maximum electrical charge current to be communicated to the EV 104, and that charge signal may be received from a communication interface 118. The charge control device 112 may communicate the maximum electrical charge current that may be drawn by the EV 104 through charge cable 105.

The charge control device 112 may also open and close a contactor 114 under certain conditions, such as when a pause or delay charge request is received or when a scheduling request or control signal of a demand request from a user 125 or utility server is received. The contactor 114 may electrically couple to the charging cable 105, which may include a SAE J1772 connector, or the like, that is coupled to the EV 104. The contactor 114 may be a 2-pole or 4-pole type. Charge control device 112 includes a low-power microcontroller that controls the contactor 114 based on a state of or user request to the EVSE 102. The charge control device 112 may also communicate information concerning the EVSE 102 to the user via the communication interface 118.

The EVSE 102 may include a metering device 116 that is operable to receive charging information, such as from a sensor 117A and/or voltage tap 117B in the EVSE 102. The sensor 117A may be a single sensor or a combination of sensors able to measure charging current, and the voltage tap 117B may measure charging voltage. Phase of incoming A and B phases may also me measured. In one or more embodiments, the sensor 117A may be a current transformer, for example, and may provide a measure of electrical current drawn by the EV 104 to the metering device 116. In one or more embodiments, a measure of voltage may be provided to the metering device 116 from the voltage tap 117B, which may be a stepped-down voltage measure from the power supply 108. The metering device 116 may then calculate charge current and/or charge voltage, for example.

The metering device 116 may also function to calculate one or more additional usage parameters, such as charge power usage or charge energy usage, such as from the measured values of charge current and/or charge voltage. The metering device 116 may be a system on chip (SoC), which is an integrated circuit (IC) that may integrate all components of a computer or other electronic system into a single chip. The metering device 116 may include digital, analog, mixed-signal, and radio-frequency functions, and memory all on a single chip substrate. In one embodiment, the metering device 116 may be an 8051 microcontroller. Other suitable microcontrollers may be used. Charging data such as charge current, charge voltage, charge power usage, charge energy usage, or any combination thereof may be stored in the memory of the metering device 116, and some or all of the charging data may be communicated periodically from the EVSE 102. Communication may be performed in periodic intervals, such as every 30 seconds, for example. Other intervals may be used.

The EVSE 102 may include a communication interface 118 that is configured and functional to allow internal communication between the various other EVSE components, such as the other microcontrollers (e.g., charge control device 112, metering device 116, and communication gateway 120). For example, the communication interface 118 may facilitate data communication between the metering device 116 and the communication gateway 120. Communication may include transmission and communication of charging data such as charge current, charge voltage, charge power, charge energy, or any combination thereof from the metering device 116 to the communication gateway 120. Communication packets may be sent in incremental periods, as discussed above. Likewise, in some instances, maximum charge current to be drawn by the EV 104 may be communicated as a control signal by the communication gateway 120 to the charge control device 112.

The communication interface 118 may be a 32-bit processor, such as an ARM® CORTEX®-M3 processor or the like. Other suitable processor types may be used. The communication interface 118 may communicate with the other devices of the EVSE 102 (e.g., charge control device 112, metering device 116 and communication gateway 120) via one or more modular communication interfaces (MCI) such as specified by ANSI/CEA-2045, for example. Other communication protocols may be used.

The communication gateway 120 provides a gateway for communication of the EVSE 102 with an EVSE server 122, such as through the Internet. The EVSE server 122 may be a cloud server accessed by the user 125 of the EVSE 102 via a communication device 126. The EVSE server 122 may include a large data table including data on the EVSE 102 and the user 125, including charge data and control signals with timestamps, priority data, schedules, access keys, user IDs, e-mails, and passwords. The data table may also include load information concerning load data for devices (e.g., electric vehicles) coupled to the load center 106.

The communication gateway 120 may, in some embodiments, allow wireless communication over a wireless local area network (WLAN), such as with the use of an Internet communication device 124, such as a modem. The Internet communication device 124 may communicate using Wi-Fi based on the IEEE 802.11 standard, BLUETOOTH, THREAD, ALLSEEN ALLIANCE, or other suitable wireless communication protocols. In some embodiments, the Internet communication device 124 may interface with a local router (not shown), which may be a wireless router, to allow operation of the wireless communication protocol. In some embodiments, a wireless router function and modem capability may be integrated into a hybrid device. The Internet communication device 124 may be any suitable communication device configured to allow access to the Internet, such as through cable (e.g., cable modem) or through optical fiber (e.g., fiber-optic modem), for example. Other types of Internet access may be provided.

In some embodiments, the communication capability with the EVSE server 122 may be through the Internet as accessed by 3G or 4G or any other mobile communications standard that allows cell phones, computers, and other portable electronic devices to access the Internet wirelessly, for example. In this instance the internet communication device 124 may be integrated into the communication gateway 120, rather than being a separate device.

As discussed above, the communication gateway 120 may be used to communicate with the EVSE server 122 through the internet communication device 124, such that signal packets may be communicated to and from the EVSE 102. Data packets may be communicated to the EVSE server 122, and control packets may be received from the EVSE server 122.

In some embodiments, the communication gateway 120 may be used to communicate charging data with the EVSE server 122. This EVSE server 122 may receive charging data from, and communicate with, other EVSEs coupled to the power grid 109. A single EVSE server 122 may be in communication with hundreds or thousands of EVSEs the same or similar to the EVSE 102.

Multiple EVSE servers 122 may be provided to communicate with different areas of the power grid 109. The charging data that is sent periodically may be stored in memory of the EVSE server 122 and may, in some embodiments, be accessed by a user 125 via a communication device 126. In one or more embodiments, the charging data may be accessed from the EVSE server 122 by a utility server 128 and compiled to gain understanding of the amount of load being drawn in respective areas of the power grid 109 and by what types of devices.

The communication device 126 may be a mobile device such as a cell phone, tablet, phablet, or the like that is capable to access the EVSE server 122, such as by using a mobile communication standard such as 3G, 4G, 5G, or the like. The user 125 may operate an application (hereinafter “App”) that is downloaded to the communication device 126. Using the App, the user 125 may access the charging data. Th charging data may include charge voltage, charge current, or charge voltage and charge current drawn by the EV 104, charge power consumed by the EVSE 102 in carrying out the charging of the EV 104, and/or charge energy consumed by the EVSE 102. Electrical rate information may also be accessed using the App.

In some embodiments, the user 125 may operate the EVSE 102 through control signals communicated through the EVSE server 122 to the EVSE 102. Thus, the user 125 may start, pause or delay (e.g., by 2 hours, 4 hours, 6 hours, or the like) charging of the EV 104. The user 125 may create charge schedules for the EVSE 102. The user 125 may receive through the App demand response requests (e.g., an event). The user 125 may send a control signal instructing the EVSE 102 of the maximum current available to be drawn by the EV 104. This maximum current may be communicated to an inverter of the EV 104.

In one or more embodiments, the communication gateway 120 may be configured and operable to receive certain data (e.g., signal packets) from the EVSE server 122. For example, in one or more embodiments, the data received from the EVSE server 122 may concern load control, charging schedules, charging priorities, or any combination thereof. For example, information concerning load control may include receiving one or more signals to shut off or lower the energy consumed by the EVSE 102 (e.g., HIGH, LOW or OFF). In other embodiments, one or more electrical loads based on an energy demand program may be shut off or otherwise limited or modulated (e.g., HIGH, LOW, OFF, or other %).

The energy demand program may be implemented through requests made to the EVSE server 122, or through communication directly with the EVSE 102. Communication directly with the EVSE 102 may be made by Open Automated Demand Response (ADR) communication protocol with the utility server 128. Thus, demand requests to shut off or otherwise limit or modulate (e.g., HIGH, LOW, OFF, or other %) may be made directly to the EVSE 102 in some embodiments.

Pre-set user priorities may be used to shut off or otherwise limit or modulate (e.g., HIGH, LOW, OFF, or other %) certain desired loads based upon which loads have been assigned priority. The ultimate goal of the load control would be to never exceed a preset peak power demand for the EVSE 102 or the building 107, so as to avoid excessive utility rate and/or to avoid causing grid stability issues. Load control may be implemented while carrying out user priorities.

In some embodiments, the user 125 may set charging schedules regarding at what times, for how long, and at what maximum charge (e.g., Amps or % of full charge) to allow the EVSE 102 to charge the EV 104. The schedules may be set using the App and the communication device 126 or through communication directly with the EVSE 102 via a computer 129 and the home area network including the internet communication device 124.

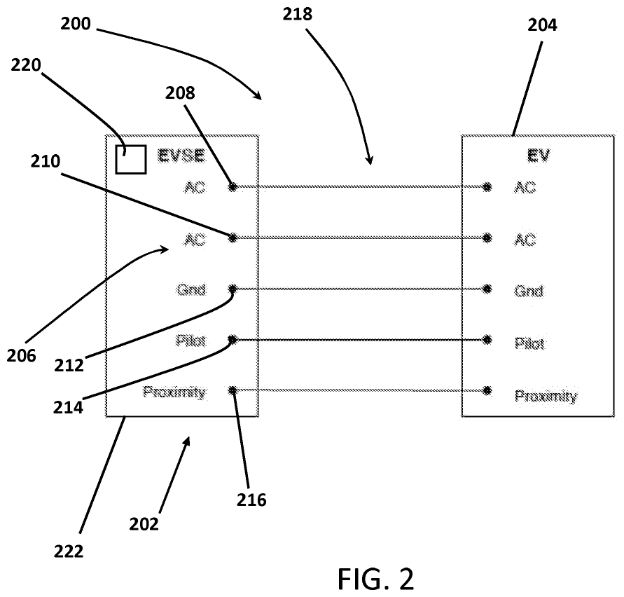

FIG. 2 illustrates an embodiment of a charging system 200 that may be used within the electrical supply system 100 of FIG. 1 or another electrical supply system. The charging system 200 includes electric vehicle supply equipment (EVSE) 202 (e.g., a charger; corresponding to the EVSE 102 of FIG. 1) and a corresponding connector 204 at an electric vehicle (e.g., the EV of FIG. 1). A plug 206 of the charger 202 (e.g., charging cable connector) may be any number of different types of AC plugs, including, for example, an SAE J1772 connector (e.g., a “J plug”, used in the United States), an IEC 62196-2 plug (e.g., used in Europe), a GB Part 2 plug (e.g., used in Great Britain and China), DC plugs, or combination AC/DC plugs.

The plug 206 of the charger 202 includes, for example, female connectors for single-phase alternating current (AC) charging of the electric vehicle 104. Alternatively, or additionally, the plug 206 of the charger 202 includes female connectors for three-phase AC charging of the electric vehicle (e.g., the EV 104). In one example, the plug 206 of the charger includes one or more connectors for direct current (DC) charging.

As shown in the example of FIG. 2, the female connectors of the plug 206 include connectors for a number of signals including, for example, a first single-phase AC connector 208 (e.g., for Line 1), a second single-phase AC connector 210 (e.g., for Neutral), a full-current protective earthing system connector 212 (e.g., for Gnd, ground, or protective earth), a post-insertion signaling connector 214 (e.g., for Pilot or control pilot), and a pre-insertion signaling connector 216 (e.g., for proximity or proximity pilot). The electric vehicle (e.g., the EV 104 of FIG. 1), for example, includes corresponding male connectors (e.g., pins). In one embodiment, the plug 206 includes male connectors, and the electric vehicle (e.g., the EV 104 of FIG. 1) includes female connectors.

Charging via the plug 206 (e.g., the first single-phase AC connector 208 and/or the second single-phase AC connector 210) of the charger 202 may be delivered at different voltages, currents, and/or powers. For example, the electric vehicle (e.g., the EV 104 of FIG. 1) may be charged by the charger 202 at 120 V AC, a max current of 12 A or 16 A, and a power of 1.44 kW or 1.92 KW. Alternatively, the electric vehicle (e.g., the EV 104 of FIG. 1) may be charged by the charger 202 at 208 to 240 V AC, a max current of less than or equal to 80 A, and a power of up to 19.2 kW. Other combinations of charging voltage, current, and power may be provided.

The proximity pilot signal prevents movement of the electric vehicle (e.g., the EV 104 of FIG. 1), for example, while the electric vehicle is connected to the charger 202 (e.g., the plug 206 of the charger 202) and identifies, for the electric vehicle, when a latch release button is activated at the charger 202. The control pilot signal signals a charging level between the charger 202 and the electric vehicle (e.g., the EV 104 of FIG. 1), and may identify presence of the electric vehicle, communicate a maximum allowable charging current, voltage, and/or power, and/or provide additional and/or different information between the charger 202 and the electric vehicle (e.g., the EV 104 of FIG. 1).

Charging may be controlled (e.g., prevented and/or interrupted) via any number of the signals. For example, charging may be controlled based on a charging schedule generated, for example, at the cloud via the control pilot signal and/or the ground signal.

The charger 202 is electrically connectable to the electric vehicle to be charged (e.g., the EV 104 of FIG. 1; the batteries of the EV to be charged) via the plug 206 of the charger 202, the plug 204 at the electric vehicle, and a charging cable 218 (e.g., a Type 1 cable or a Type 2 cable; with connectors corresponding to the plug 204 and the plug 206 on opposite ends of the charging cable 218, respectively). Type 1 cables are single-phase charging cables, while a Type 2 cable may a single-phase cable or a three-phase cable. Type 2 cables may be used for high-capacity electric vehicles.

Charging cable connectors (e.g., and the corresponding plugs 204 and 206 at the electric vehicle and the charger 202) include Type 1 connectors and Type 2 connectors. Type 1 connectors include five pins, and Type 2 connectors include seven pins. The seven pins of the Type 2 connector include a locking pin that locates and secures the Type 2 connector to the electric vehicle (e.g., the EV 104 of FIG. 1) or the EVSE 202. The Type 1 connector may include a latch that locates and secures the Type 1 connector to the electric vehicle (e.g., the EV 104 of FIG. 1) or the EVSE 202.

At a maximum power output of the charger 202, for example, temperatures in and/or at the charger 202 may approach and/or reach one or more threshold temperatures, respectively. The charger 202 may include one or more temperature sensors 220 to determine (e.g., track) one or more temperatures in and/or at the charger 202, respectively. The one or more tracked temperatures may be temperatures corresponding to critical components of the charger 202 (e.g., an AC-DC converter of the charger 202 or a processor of the charger 202) and/or parts of the charger 202, at which temperatures rise and/or reach threshold temperatures quickest when the charger 202 is operating at the maximum power output.

In one embodiment, a temperature of the plug 206 of the charger 202 gets hottest fastest within the charger 202, and the one or more temperature sensors 220 include a temperature sensor 220 located on and/or within the plug 206 of the charger 202. The one or more temperature sensors 220 may include temperature sensors 220 at more and/or different locations of the charger 202. For example, the charger 202 also includes a plug at which the charger 202 is electrically connected to the grid (e.g., a grid plug), and the one or more temperature sensors 220 also include a temperature sensor on and/or in the grid plug.

The one or more temperature sensors 220 may include any number of different types of temperature sensors. For example, the one or more temperature sensors 220 may include negative temperature coefficient (NTC) thermistors, resistance temperature detectors (RTDs), thermocouples, semiconductor-based sensors, one or more other types of temperature sensors, or any combination thereof.

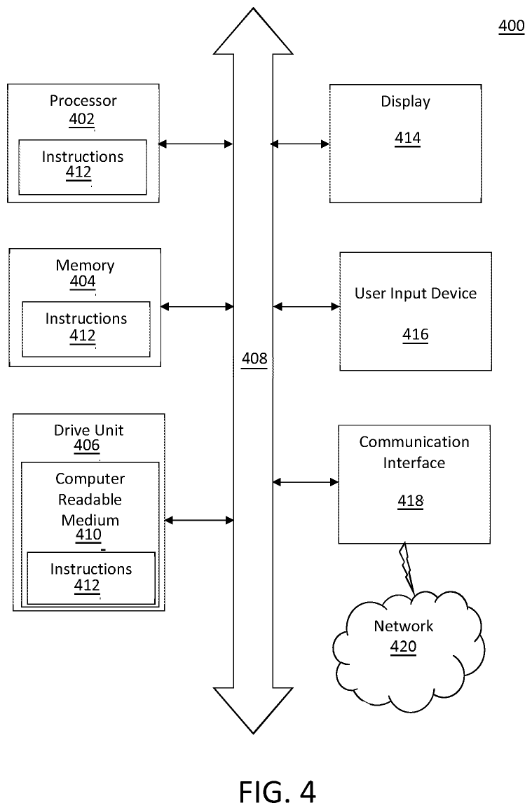

The charger 202 includes a housing 222 that supports a plurality of components of the charger 202 (e.g., some or all of the components of the computer system of FIG. 4, including the processor 402 and the memory 404). For example, the housing 222 supports the plug 206, the grid plug, an AC-DC converter, which is electrically connected to the plug 206 and the grid plug, a processor (e.g., the processor 402 of FIG. 4), a memory (e.g., the memory 404 of FIG. 4), and/or other components of the charger 202. The housing 222 may be any number of sizes and shapes, and may be made of any number of materials.

The one or more threshold temperatures (e.g., corresponding to one or more locations at and/or in the charger 202) may be stored in a memory of the charger 202 or another memory (e.g., memory of the EVSE server 122 of FIG. 1). In one embodiment, the one or more threshold temperatures are stored within the memory (e.g., of the charger 202) at manufacturing. In one embodiment, the one or more threshold temperatures may be changeable within the memory of, for example, the charger 202.

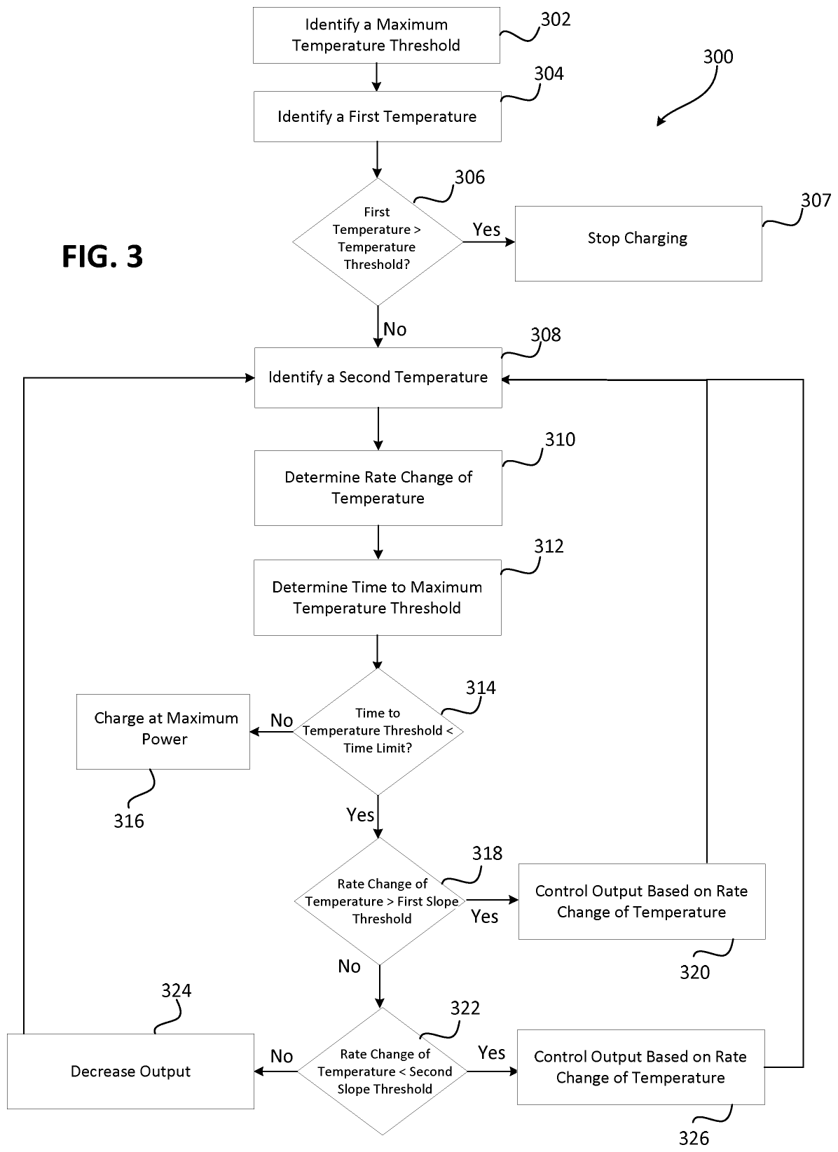

FIG. 3 shows a flowchart of one embodiment of a method 300 for temperature management of EVSE. The method 300 may be performed using the electrical supply system 100 shown in FIG. 1, the charging system 200 shown in FIG. 2, the computer system 400 shown in FIG. 4, a controller of the charging system 200 shown in FIG. 2, and/or another system or controller. The flowchart of FIG. 3 illustrates the method 300 for a single electric vehicle. The method, however, may be implemented for a plurality of electric vehicles, and corresponding EVSE, in parallel. The method 300 is implemented in the order shown, but other orders may be used. Additional, different, or fewer acts may be provided.

In act 302, a processor identifies a maximum temperature threshold for an electric vehicle charger (e.g., EVSE). The processor is a processor of the EVSE (e.g., the EVSE 102), a processor of a server in communication with the EVSE (e.g., the EVSE server 122 or the Cloud), another processor, or any combination thereof (e.g., operating in parallel).

The maximum temperature threshold may depend on the particular EVSE and may correspond to a component on and/or in the EVSE. For example, the maximum temperature threshold may be 85° C. and may correspond to a location on and/or within a plug of the EVSE. Other maximum temperature thresholds and/or other corresponding components on and/or in the EVSE may be used.

The maximum temperature threshold may be stored in a memory (e.g., of the EVSE) and may be identified by the processor in the memory. The maximum temperature threshold may be stored in the memory at manufacturing, may be user definable, and/or may be user changeable.

In act 304, the processor identifies a first temperature from a sensor at a first time point. In one embodiment, the processor is in communication with the sensor and receives the first temperature from the sensor (e.g., via a wired and/or wireless communication). In another embodiment, the sensor determines the first temperature and transmits (e.g., via wired and/or wireless communication) the first temperature to the memory (e.g., of the EVSE) in communication with the sensor for storage of the first temperature at the memory. The processor then identifies the first temperature (e.g., and the corresponding first time point) from the memory.

The sensor may be at any number of locations in and/or on the EVSE. For example, the sensor is located on and/or in a cable lock at a receptacle (e.g., a plug) of the EVSE.

In act 306, the processor determines whether the first temperature identified in act 304 is greater than the maximum temperature threshold identified in act 302. For example, the processor compares the first temperature identified in act 304 to the maximum temperature threshold identified in act 302. If, based on the comparison, the first temperature identified in act 304 is greater than the maximum temperature threshold identified in act 302, the method moves to act 307. If, based on the comparison, the first temperature identified in act 304 is less than the maximum temperature threshold identified in act 302, the method moves to act 306.

In act 307, the processor stops (e.g., interrupts, aborts) charging by the EVSE (e.g., via the control pilot signal and/or the ground signal). At act 307, the processor has identified the EVSE as overheating or soon to overheat, and stops charging to avoid damage to the EVSE, damage to the electric vehicle, danger to a user, or any combination thereof.

In act 308, the processor identifies a second temperature from the sensor at a second time point. The second time point is after the first time point. In one embodiment, the processor is in communication with the sensor and receives the second temperature from the sensor (e.g., via a wired and/or wireless communication). In another embodiment, the sensor determines the second temperature and transmits (e.g., via wired and/or wireless communication) the second temperature to the memory (e.g., of the EVSE) in communication with the sensor for storage of the second temperature at the memory. The processor then identifies the second temperature (e.g., and the corresponding second time point) from the memory.

In act 310, the processor determines a rate change of temperature based on at least the first temperature at the first time point and the second temperature at the second time point. The processor may, for example, determine the rate change of temperature by calculating a temperature difference and a time difference, and dividing the temperature difference by the time difference. For example, the calculated temperature difference is a difference between the second temperature identified in act 308 and the first temperature identified in act 304, and the calculated time difference is a difference between the second time point and the first time point.

In one embodiment, the sensor is configured to determine, store, and/or transmit a new temperature at a predetermined interval (e.g., every 0.1, 0.2, 0.5, 1.0, 2.0, 5.0 s). The processor may be configured to determine a new rate change of temperature at, for example, the same predetermined interval.

In one embodiment, the rate change of temperature is determined in act 310 based on more than two temperatures at more than two time points, respectively. For example, the processor may determine a best fit (e.g., a best fit line) of a dataset including more than two temperatures (e.g., three temperatures, five temperatures, ten temperatures, twenty temperatures) at more than two respective time points (e.g., three time points, five time points, ten time points, twenty time points). The rate change of temperature may be determined in act 310 based on a slope of, for example, the best fit line.

In act 312, the processor determines a time to maximum temperature threshold based on the rate change of temperature determined in act 306, and the maximum temperature threshold identified in act 302. The processor may determine the time to maximum temperature threshold by determining a difference between the maximum temperature threshold identified in act 302 and the second temperature identified in act 308, and dividing the determined difference by the determined rate change of temperature determined in act 310.

As an example, with a maximum temperature threshold identified in act 302 as 82° C., a second temperature identified in act 308 as 74° C., and a rate change of temperature determined in act 306 as 4.0° C./s, the processor may determine the time to maximum temperature threshold to be 2 seconds. As another example, with a maximum temperature threshold identified in act 302 as 82° C., a second temperature identified in act 308 as 32° C., and a rate change of temperature determined in act 306 as 0.01° C./s, the processor may determine the time to maximum temperature threshold to be 5,000 seconds.

In act 314, the processor determines whether the time to maximum temperature threshold determined in act 312 is less than a predetermined time limit. For example, the processor compares the determined time to maximum temperature threshold to the predetermined time limit.

The predetermined time limit may be stored in the memory, and the processor may identify the predetermined time limit from the memory for the comparison of the determined time to maximum temperature threshold to the predetermined time limit. The predetermined time limit may correspond to a time for a remaining charge to be provided by the EVSE based on sensed and/or determined state of charge (SoC) of the electric vehicle to be charged, may be an average charge time (e.g., based on experimental and/or historical data) for the electric vehicle to be charged, or may be another amount of time. For example, the predetermined time limit may be 30 minutes (e.g., 1,800 seconds), 60 minutes (e.g., 3,600 seconds), 90 minutes (e.g., 5,400 seconds), 120 minutes (e.g., 7,200 seconds), 240 minutes (e.g., 14,400 seconds), or another amount of time.

When, based on the comparison in act 314, the processor determines the time to maximum temperature threshold is not less than the predetermined time limit (e.g., is greater than or equal to the predetermined time limit), the method 300 moves to act 316. When, based on the comparison in act 314, the processor determines the time to maximum temperature threshold is less than the predetermined time limit, the method 300 moves to act 318.

The predetermined time limit may be stored in the memory, and the processor may identify the predetermined time limit from the memory. In one embodiment, the predetermined time limit is set at manufacturing of the EVSE. In another embodiment, the predetermined time limit may be set and/or changed by a user.

In act 316, the processor controls charging by the EVSE (e.g., via the control pilot signal), such that the EVSE charges at a maximum output power of the EVSE. At act 316, the processor has identified the EVSE will not overheat before, for example, the electric vehicle to be charged has been fully charged.

In act 318, the processor determines whether the rate change of temperature determined in act 310 is greater than a first predetermined slope threshold. For example, the processor compares the rate change of temperature to the first predetermined slope threshold. The first predetermined slope threshold is, for example, a positive slope threshold.

The first predetermined slope threshold may be stored in the memory. The first predetermined slope threshold may be stored in the memory at manufacture of the EVSE, may be user definable, and/or may be user changeable. The processor identifies the first predetermined slope threshold from, for example, the memory and compares the rate change of temperature determined in act 310 to the identified first predetermined slope threshold.

In one embodiment, the first predetermined slope threshold is determined experimentally and set at manufacturing of the EVSE. In another embodiment, the first predetermined slope is determined based on the rate change of temperature determined in act 310, a state of charge of the electric vehicle, the second temperature determined in act 308, and the maximum temperature threshold identified in act 302. For example, based on the state of charge of the electric vehicle and a current output power of the EVSE, the processor may estimate a time until the electric vehicle is fully charged. The processor may determine the slope threshold based on a temperature difference between the maximum temperature threshold identified in act 302, the second temperature identified in act 308, and the estimated time (e.g., the temperature difference divided by the estimated time). In other words, the first slope threshold may be dynamic and may be predetermined with each determination of a rate change of temperature.

As an example, the first predetermined slope threshold is 4.0° C./s, and the rate change of temperature determined in act 310 is 3.0° C./s. Other predetermined slope thresholds may be provided, and/or different rate change of temperatures may be determined in act 310.

When, based on the comparison in act 318, the determined rate change of temperature is greater than the first predetermined slope threshold, the method 300 moves to act 320. When, based on the comparison in act 318, the determined rate change of temperature is not greater than the first predetermined slope threshold (e.g., the determined rate change of temperature is less than or equal to the first predetermined slope threshold), the method 300 moves to act 322.

In act 320, the processor controls an output of the EVSE based on the rate change of temperature determined in act 310. The output of the EVSE may be controlled by controlling an output current of the EVSE. The processor may control the output of the EVSE, such that output power of the EVSE is decreased (e.g., an output current of the EVSE is decreased). In one embodiment, the decrease in the output power of the EVSE is inversely proportional to a temperature difference of the rate change of temperature determined in act 310. For example, the processor may decrease the output power of the EVSE by a percentage equal to a difference between the second temperature identified in act 308 and the first temperature identified in act 304.

As an example, if the second temperature determined in act 308 is 80° C. and the first temperature determined in act 304 is 76° C. (e.g., with a time difference between the second time point and the first time point of 1.0 s), the processor determines a temperature difference of 4° C. as part of the determination of the rate change of temperature in act 310. The processor may thus decrease the output power of the EVSE by 4% in act 320. Other control of the output of the EVSE based on the rate change of temperature determined in act 310 and/or the second temperature identified in act 308 and the first temperature identified in act 304 may be provided. For example, in one embodiment, the processor may multiply the determined temperature difference by a predetermined multiplier (e.g., 2) to determine the percentage. Using the examples of the first temperature and the second temperature above, in such an embodiment, the processor may decrease the output power of the EVSE by 8% in act 320. Other multipliers such as, for example, 0.5, 0.75, 1.25, or 1.5 may be used.

In one embodiment, after act 320, the method 300 returns to act 308, and the method 300 is repeated starting at act 308 using a newly identified temperature (e.g., a third temperature at a third time point), as described below.

In another embodiment, after act 320, the processor identifies a new temperature at a new time point (e.g., the third temperature at the third time point, which is after the second time point) and determines a new rate change of temperature based on the new temperature at the new time point (e.g., based on a new temperature difference between the third temperature at the third time point and the second temperature at the second time point). The method 300 then returns to act 318 and repeats act 318 based on the determined new rate change of temperature. In this embodiment, the processor may repeat this loop of the method 300 until the newly determined rate change of temperature is less than the first predetermined slope threshold.

In yet another embodiment, control of the output of the EVSE within this loop may be provided by a controller (e.g., a feedback controller such as a PI controller or a PID controller). The controller may be, for example, a software routine executed by the processor or hardware (e.g., a PID controller) that is separate from the processor. In one embodiment, the controller is PID controller logic implemented on the processor.

Within the repeated loop, the PID controller, for example, determines an error value as a difference between a desired temperature (e.g., at least one degree less than the maximum temperature threshold, such as 80° C., 81° C., or 82° C.; a predetermined target temperature) and a current temperature (e.g., the second temperature identified in act 308). The error value is an input of the PID controller, and the PID controller outputs, based on the error value input, a target power output of the EVSE (e.g., a target output current of the EVSE). The processor controls the charging by the EVSE (e.g., the output current of the EVSE) based on the target power output (e.g., the target output current) output by the PID controller.

The PID controller uses three control terms for control: a proportional control term; an integral control term; and a derivative control term. The proportional control term is proportional to the current error value. The integral control term accounts for past values of the error value, and the PID controller integrates the past error values over time. The derivative control term accounts for a current rate of change of the error value. Constants corresponding to the proportional control term, the integral control term, and the derivative control term, respectively, are tuned prior to use of the PID controller (e.g., at manufacturing of the EVSE) to optimize the PID controller for the particular application of the PID controller (e.g., for the particular sensor at the particular location on and/or in the EVSE). The error value, and thus the target power output of the EVSE output by the PID controller, are updated with each identification of a new temperature from the sensor.

At the second time point, for example, the derivative control term is based on the rate change of temperature determined in act 310. The PID controller may determine the current rate of change of the error value, on which the derivative control term is based, by subtracting two times the desired temperature divided by the time difference (e.g., between the second time point and the first time point) from the rate change of temperature determined in act 310. In other words, the PID controller determines a first error value as a difference between the desired temperature and the first temperature, and determines a second error value as a difference between the desired temperature and the second temperature. The PID controller may determine the current rate of change of the error value by determining a difference between the second error value and the first error value, and dividing by the time difference (e.g., between the second time point and the first time point).

In act 322, the processor determines whether the rate change of temperature determined in act 310 is less than a second predetermined slope threshold. For example, the processor compares the rate change of temperature to the second predetermined slope threshold. The second predetermined slope threshold is less than the first predetermined slope threshold. In one embodiment, the second predetermined slope threshold is a positive slope threshold. In another embodiment, the second predetermined slope threshold is, for example, a negative slope threshold.

The second predetermined slope threshold may be stored in the memory. The second predetermined slope threshold may be stored in the memory at manufacture of the EVSE, may be user definable, and/or may be user changeable. The processor identifies the second predetermined slope threshold from, for example, the memory and compares the rate change of temperature determined in act 310 to the identified second predetermined slope threshold.

As an example, the second predetermined slope threshold is 0.0001° C./s, and the rate change of temperature determined in act 310 is 0.00005.0° C./s. Other predetermined slope thresholds may be provided, and/or different rate change of temperatures may be determined in act 310.

When, based on the comparison in act 322, the determined rate change of temperature is not less than the second predetermined slope threshold (e.g., the determined rate change of temperature is greater than or equal to the second predetermined slope threshold), the method 300 moves to act 324. When, based on the comparison in act 322, the determined rate change of temperature is less than the second predetermined slope threshold, the method 300 moves to act 326.

In act 324, the processor controls charging by the EVSE (e.g., via the control pilot signal). For example, the processor controls the charging by the EVSE, such that a power output of the EVSE is decreased. In one embodiment, the processor decreases a power output of the EVSE by a predetermined amount or a predetermined percentage. For example, the processor decreases the power output by the EVSE by 1%, 2%, 3%, or another percentage. Other control of the EVSE (e.g., decrease of the power output of the EVSE) may be provided. After act 324, the method 300 returns to act 308, and the method 300 is repeated starting at act 308.

In act 326, the processor controls an output of the EVSE based on the rate change of temperature determined in act 310. The output of the EVSE may be controlled by controlling the output current of the EVSE. The processor may control the output of the EVSE, such that the output power of the EVSE is increased (e.g., an output current of the EVSE is increased). In one embodiment, the increase in the output power of the EVSE is inversely proportional to a temperature difference of the rate change of temperature determined in act 310. For example, the processor may increase the output power of the EVSE by a percentage equal to an absolute value of a difference between the second temperature identified in act 308 and the first temperature identified in act 304.

As an example, if the second temperature determined in act 308 is 76° C. and the first temperature determined in act 304 is 80° C. (e.g., with a time difference between the second time point and the first time point of 1.0 s), the processor determines a temperature difference of −4° C. as part of the determination of the rate change of temperature in act 310. The processor may thus increase the output power of the EVSE by 4% in act 326. Other control of the output of the EVSE based on the rate change of temperature determined in act 310 and/or the second temperature identified in act 308 and the first temperature identified in act 304 may be provided. For example, in one embodiment, the processor may multiply the determined temperature difference by a predetermined multiplier (e.g., 2) to determine the percentage. Using the examples of the first temperature and the second temperature above, in such an embodiment, the processor may increase the output power of the EVSE by 8% in act 326. Other multipliers such as, for example, 0.5, 0.75, 1.25, or 1.5 may be used.

After act 326, the method 300 returns to act 308, and similar to after act 324, the method 300 is repeated starting at act 308. For example, in repeated act 308, the processor determines a third temperature from the sensor at a third time point. The third time point is after the second time point. In one embodiment, a time difference between the third time point and the second time point is the same as a time difference between the second time point and the first time point. In another embodiment, the time difference between the third time point and the second time point is different than the time difference between the second time point and the first time point.

In repeated act 310, the processor determines a new rate change of temperature based on the second temperature at the second time point and the third temperature at the third time point. In other words, for calculating the new rate change of temperature, the second temperature and the second time point replace (e.g., are used as) the first temperature and the first time point, respectively, and the third temperature and the third time point replace (e.g., are used as) the second temperature and the second time point, respectively. The new rate change of temperature determined in repeated act 310 may be used for repeated acts 312-324, for example.

Other and/or different control may be provided. For example, the processor controlling the charging by the EVSE in act 324, such that the power output of the EVSE is decreased may only be provided when the rate change of temperature determined in act 310 is positive. In other words, the processor may not decrease the power output of the EVSE when the monitored temperature is decreasing. As another example, the method 300 may be performed in parallel for any number of different tracked temperatures at the EVSE and/or for any number of EVSEs.

The method 300 of FIG. 3 is proactive instead of reactive, and prevents the maximum temperature threshold from being reached. The method 300 of FIG. 3, for example, optimizes charging times, as stopping and starting of the charging over a prolonged charging session is avoided. In other words, control of the output current of the EVSE provided by the method 300 of FIG. 3 reduces charging time while preventing a maximum temperature threshold for the EVSE from being reached.

FIG. 4 shows one embodiment of a computer system for use with the electrical supply system 100 of FIG. 1 and/or the charging system 200 of FIG. 2. FIG. 4 shows an illustrative embodiment of a general computer system 400. The computer system 400 may include a set of instructions that may be executed to cause the computer system 400 to perform any one or more of the methods or computer-based functions disclosed herein. The computer system 400 may operate as a standalone device or may be connected (e.g., using a network) to other computer systems or peripheral devices. Any of the components discussed above may be a computer system 400 or a component in the computer system 400. For example, part of the EVSE 102 and/or the EVSE server 122 of the electrical supply system 100 of FIG. 1 may be or include a computer system 400 or a component in the computer system 400. Additional, fewer, and/or different components of, for example, the electrical supply system 100 of FIG. 1 may be a computer system 400 or a component in the computer system 400.

In a networked deployment, the computer system 400 may operate in the capacity of a server or as a client user computer in a client-server user network environment, or as a peer computer system in a peer-to-peer (or distributed) network environment. The computer system 400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a personal trusted device, a web appliance, a network router, switch or bridge, a car, or any other machine capable of executing a set of instructions (sequential or otherwise) that specify actions to be taken by that machine. In one embodiment, the computer system 400 may be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402 such as, for example, a central processing unit (CPU), a graphics-processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that may communicate via a bus 408. The memory 404 may be a main memory, a static memory, or a dynamic memory. The memory 404 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random-access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid-state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in a disk or optical drive unit 406 (e.g., a disk drive unit).

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400. In other embodiments, the input device 416 includes a credit card reader, an RFID reader, and/or other devices.

In one embodiment, as depicted in FIG. 4, the computer system 400 may also include the disk or optical drive unit 406. The disk drive unit 406 may include a computer-readable medium 410, in which one or more sets of instructions 412 (e.g., software) may be embedded. Further, the instructions 412 may embody one or more of the methods or logic as described herein. In one embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 may communicate voice, video, audio, images or any other data over the network 420. Further, the instructions 412 may be transmitted or received over the network 420 via a communication port 418. The communication port 418 may be a part of the processor 402 or may be a separate component. The communication port 418 may be created in software or may be a physical connection in hardware. The communication port 418 is configured to connect with the network 420 or another network, external media, the display 414, any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof, and may be representative of the network of FIG. 1. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An electric vehicle charger comprising:
a processor in communication with a sensor associated with the electric vehicle charger, the processor being configured to:
identify a first temperature and a second temperature from the sensor, the first temperature being at a first time point and the second temperature being at a second time point, the second time point being after the first time point;
determine a rate change of temperature based on at least the first temperature at the first time point and the second temperature at the second time point; and
prevent a maximum temperature threshold for the electric vehicle charger from being reached, wherein the processor being configured to prevent the maximum temperature threshold from being reached comprises the processor being configured to control an output of the electric vehicle charger based on the determined rate change of temperature and a predicted time to maximum temperature threshold.

2. The electric vehicle charger of claim 1, wherein the processor is further configured to:
identify the maximum temperature threshold for the electric vehicle charger;
determine the predicted time to maximum temperature threshold based on the determined rate change of temperature and the identified maximum temperature threshold; and
compare the predicted time to maximum temperature threshold to a predetermined time limit,
wherein the processor being configured to control the output of the electric vehicle charger based on the determined rate change of temperature and the predicted time to maximum temperature threshold comprises the processor being configured to control the output of the electric vehicle charger based on the determined rate change of temperature and the predicted time to maximum temperature threshold when, based on the comparison, the predicted time to maximum temperature threshold is less than the predetermined time limit.

3. The electric vehicle charger of claim 1, further comprising the sensor,
wherein the processor being configured to identify the first temperature and the second temperature from the sensor comprises the processor being configured to receive the first temperature and the second temperature from the sensor.

4. The electric vehicle charger of claim 3, further comprising:
a charging cable connector; and
a housing configured to support the processor and the charging cable connector,
wherein the sensor is located at the charging cable connector.

5. The electric vehicle charger of claim 2, further comprising a memory in communication with the processor, the memory being configured to store the maximum temperature threshold and the predetermined time limit,
wherein the processor is further configured to identify the maximum temperature threshold and the predetermined time limit from the memory.

6. The electric vehicle charger of claim 2, wherein the processor is further configured to:
set a power of the electric vehicle charger to a maximum power when, based on the comparison, the predicted time to maximum temperature threshold is greater than the predetermined time limit.

7. The electric vehicle charger of claim 1, wherein the processor being configured to control the output of the electric vehicle charger based on the determined rate change of temperature and the predicted time to maximum temperature threshold comprises the processor being configured to:
compare the determined rate change of temperature to a predetermined slope threshold; and
decrease an output power of the electric vehicle charger when, based on the comparison of the determined rate change of temperature to the predetermined slope threshold, the determined rate change of temperature is greater than the predetermined slope threshold.

8. The electric vehicle charger of claim 7, wherein the decrease of the output power of the electric vehicle is inversely proportional to a difference between the second temperature and the first temperature.

9. The electric vehicle charger of claim 7, wherein the processor being configured to control the output of the electric vehicle charger based on the determined rate change of temperature and the predicted time to maximum temperature threshold comprises the processor being configured to:
decrease the output power of the electric vehicle charger by a predetermined percentage when, based on the comparison of the determined rate change of temperature to the predetermined slope threshold, the determined rate change of temperature is less than the predetermined slope threshold.

10. The electric vehicle charger of claim 7, wherein the processor being configured to decrease the output power of the electric vehicle charger comprises the processor being configured to decrease an output current by the electric vehicle charger.

11. The electric vehicle charger of claim 7, wherein the predetermined slope threshold is a first predetermined slope threshold, and
wherein the processor being configured to control the output of the electric vehicle charger based on the determined rate change of temperature and the predicted time to maximum temperature threshold comprises the processor being configured to:
compare the determined rate change of temperature to a second predetermined slope threshold; and
increase an output power of the electric vehicle charger when, based on the comparison of the determined rate change of temperature to the second predetermined slope threshold, the determined rate change of temperature is less than the second predetermined slope threshold.

12. The electric vehicle charger of claim 1, further comprising:
a feedback controller configured to output a target output current based on one or more inputs to the feedback controller, the one or more inputs to the feedback controller being based on the first temperature and the second temperature identified from the sensor, and previous current output
wherein the processor is configured to control the output of the electric vehicle charger based on the target output current output by the feedback controller.

13. The electric vehicle charger of claim 12, wherein the feedback controller is PID controller logic implemented on the processor.

14. The electric vehicle of claim 13, wherein the processor is further configured to:
identify a predetermined target temperature, the predetermined target temperature being less than the maximum temperature threshold; and
determine a first error and a second error, the first error being a difference between the predetermined target temperature and the first temperature and the second error being a difference between the predetermined target temperature and the second temperature,
wherein the one or more inputs to the feedback controller include the first error and the second error.

15. The electric vehicle charger of claim 13, further comprising a housing configured to support the processor and the feedback controller.

16. A controller for temperature management of electric vehicle supply equipment (EVSE), the controller comprising:
a processor in communication with a sensor associated with the EVSE, the processor being configured to:
identify a maximum temperature threshold for the EVSE;
receive a first temperature and a second temperature from the sensor, the first temperature being at a first time point and the second temperature being at a second time point, the second time point being after the first time point;
determine a rate change of temperature based on at least the first temperature at the first time point and the second temperature at the second time point;
determine a time to maximum temperature threshold based on the determined rate change of temperature and the identified maximum temperature threshold;
compare the determined time to maximum temperature threshold to a predetermined time limit; and
when, based on the comparison, the determined time to maximum temperature threshold is less than the predetermined time limit, control an output of the EVSE based on the determined rate change of temperature.

17. The controller of claim 16, wherein the controller is a controller of the EVSE.

18. The controller of claim 16, wherein the processor being configured to control the output of the EVSE based on the determined rate change of temperature comprises the processor being configured to:
compare the determined rate change of temperature to a predetermined slope threshold; and
when, based on the comparison of the determined rate change of temperature to the predetermined slope threshold, the determined rate change of temperature is greater than the predetermined slope threshold, decrease an output power of the EVSE.

19. A method for temperature management of electric vehicle supply equipment (EVSE), the method comprising:
identifying, by a processor, a first temperature and a second temperature from a sensor associated with the EVSE, the first temperature being at a first time point and the second temperature being at a second time point, the second time point being after the first time point;
determining, by the processor, a rate change of temperature based on at least the first temperature at the first time point and the second temperature at the second time point;
preventing a maximum temperature threshold for the EVSE from being reached, preventing the maximum temperature threshold for the EVSE from being reached comprising controlling, by the processor, an output of the EVSE based on the determined rate change of temperature and a predicted time to maximum temperature threshold, controlling the output of the EVSE comprising:
generating, by a feedback controller, a target output current based on one or more inputs to the feedback controller, the one or more inputs to the feedback controller being based on the first temperature and the second temperature identified from the sensor; and
controlling, by the processor, the output of the EVSE based on the target output current generated by the feedback controller.

20. The method of claim 19, further comprising:
identifying, by the processor, the maximum temperature threshold for the EVSE;
determining, by the processor, the predicted time to maximum temperature threshold based on the determined rate change of temperature and the identified maximum temperature threshold; and
comparing, by the processor, the predicted time to maximum temperature threshold to a predetermined time limit,
wherein generating, by the feedback controller, the target output current comprises generating, by the feedback controller, the target output current based on the one or more inputs to the feedback controller when, based on the comparing, the predicted time to maximum temperature threshold is less than the predetermined time limit, and
wherein the feedback controller is PID controller logic implemented on the processor.
